(19) United States
(12) Patent Application Publication
(10) Pub. No.: US 2016/0282068 A1
(43) Pub. Date: Sep. 29, 2016

(54) VIBRATORY SCALE REDUCTION IN HOT WATER HEATERS, STEAM GENERATORS AND RELATED DEVICES

(71) Applicants: Michael B. Reckner, Dayton, OH (US); Timothy L. Cupp, Hillsboro, OH (US)

(72) Inventors: Michael B. Reckner, Dayton, OH (US); Timothy L. Cupp, Hillsboro, OH (US)

(21) Appl. No.: 15/056,220

(22) Filed: Feb. 29, 2016

Related U.S. Application Data
(60) Provisional application No. 62/137,884, filed on Mar. 25, 2015.
(60) Provisional application No. 62/199,358, filed on Jul. 31, 2015.

(51) Int. Cl. F28G 7/00; A47L 15/42; A47L 15/14; A47J 27/04

(52) U.S. Cl. CPC F28G 7/00; A47J 27/04; A47L 15/4285; A47L 15/14; A47J 2027/043

(57) ABSTRACT

A steam generator for generating steam by boiling water, or other hot water heating device, in either case such as for use in a steam cooker or warewasher, includes a tank structure providing a heating chamber for holding water and including a water inlet, a steam outlet and a water drain outlet. A heating element is located for heating water within the heating chamber so as to generate steam. At least one transducer is located on or within the tank structure to cause water within the heating chamber to vibrate so as to reduce scale build-up on one or more surfaces within the heating chamber.

### TECHNICAL FIELD

This application relates generally to steam generators and other hot water heating devices and, more specifically, to a steam generator or other hot water heating device incorporating a vibratory feature that reduces scale formation.

### BACKGROUND

Steam generators are used in a variety of applications such as steam cooking systems. Many such steam generators are used in high volume situations. A typical steam generator includes a heating chamber (e.g., within a tank) with an associated heating element (e.g., gas or electric) that is used to heat water within the tank. As steam is produced and exits the tank (e.g., for delivery to a steam oven cooking chamber), water is added back into the tank. The steam production process produces scale deposits in the tank (e.g., on the inner surfaces of the tank walls and on any internal heating element). To reduce such scale build-up the water delivered into the tank may be filtered and/or treated by known water softening techniques. However, scale build-up still occurs, and such water pre-treatment systems can be expensive. Steam generators can also be periodically “delimed” using a chemical treatment process to remove the scale and flush it out of the steam generator tank. However, deliming is an added, undesired maintenance task for the end customer using the steam generator. Similar problems are encountered in steam generators and/or booster tanks used in warewash machines, as well as other types of water heating tanks.

It would be desirable to provide water heating tanks, such as steam generators, with reduced operational and maintenance costs relating to scale formation.

### SUMMARY

In one aspect, a steam generator for generating steam by boiling water, or other hot water heating device, in either case such as for use in a steam cooker or warewasher, includes a tank structure providing a heating chamber for holding water and including a water inlet, a steam outlet and a water drain outlet. At least one heating element is located for heating water within the heating chamber so as to generate steam. At least one transducer is located on or within the tank structure to cause water within the heating chamber to vibrate so as to reduce scale build-up on one or more surfaces within the heating chamber.

In another aspect, a steam cooker includes steam cooking chamber and a steam generator external of the steam cooking chamber and plumbed to deliver steam from a steam outlet of the steam generator to a steam inlet of the steam cooking chamber. The steam generator includes a tank structure providing a heating chamber for holding water and at least one heating element associated with the tank structure for heating water within the heating chamber so as to generate steam. At least one transducer is associated with the tank structure to cause water within the heating chamber to vibrate so as to reduce scale build-up on one or more surfaces within the heating chamber.

In either of the foregoing aspects, the heating element can be formed by one or more submerged resistive heating elements, and a plurality of transducers are located on a sidewall of the tank and aligned vertically and horizontally with the resistive heating elements.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic view of a steam cooking system including a steam generator; and

FIG. 2 is a cross-sectional view of the steam generator taken along line 2-2 of FIG. 1, with the resistive heating element(s) shown schematically in dashed line form and with the inlet pipe not shown; and

FIG. 3 is a schematic depiction of a warewash machine with a hot water booster and steam generator including vibratory scale reduction.

### DETAILED DESCRIPTION

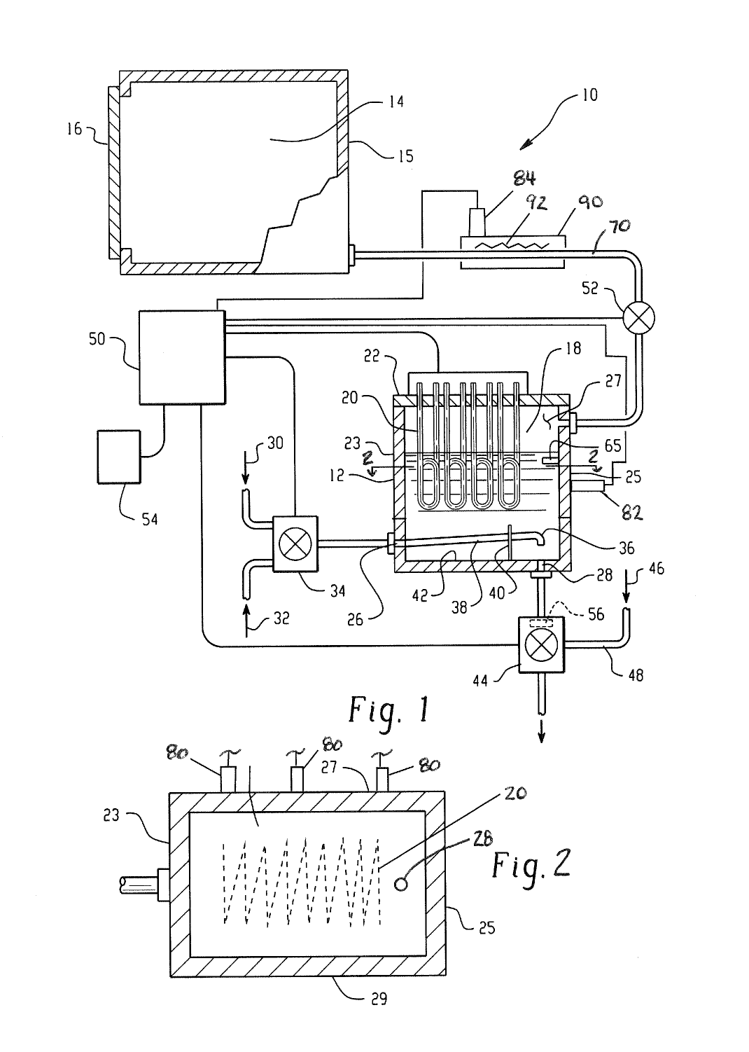

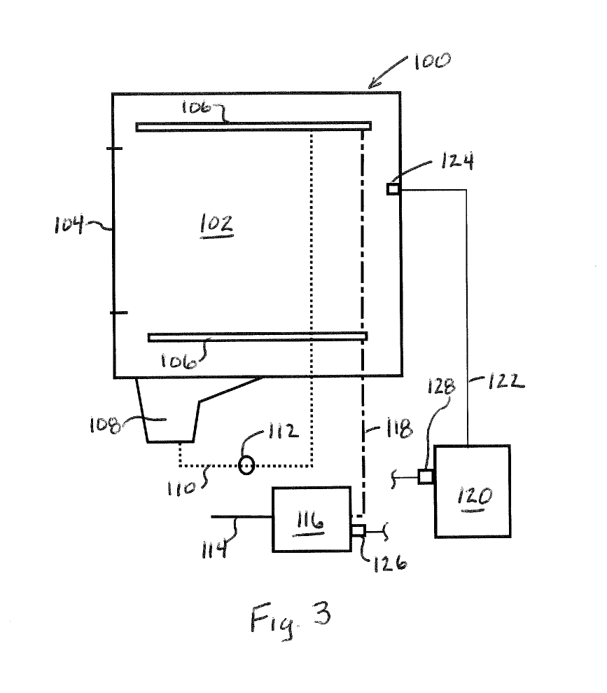

Referring to FIGS. 1 and 2, an exemplary steam cooker 10 includes a steam generator 12 for generating steam and a cooking chamber 14 that is in communication with the steam generator. The cooking chamber 14 may be formed by an insulated housing 15 and includes a door 16 that is movable between open and closed positions to provide and inhibit access to the cooking chamber. The steam generator 12 includes opposing minor sidewalls 23, 25, opposing major sidewalls 27, 29, bottom wall 42 and top plate 22 defining a heating chamber 18 where water is heated (e.g., by submerged resistive heating element or elements 20) to generate steam. The steam cooker could be a countertop steamer or a floor-mounted steamer, both of which are commonly used in restaurants and other commercial cooking establishments.

The steam generator 12 includes an inlet 26, which in the illustrated embodiment is an opening in the steam generator wall through which an inlet pipe 38 passes, for ingress of water into the heating chamber 18 from a water source, and an outlet 28 for egress or draining of water from the heating chamber (e.g., when the chamber is to be drained based upon operation of a drain flow control device 44 (e.g., a valve), which in some cases may also control flow of cooling water from a water source (represented by arrow 46) that is connected to conduit 48). A temperature sensor 56 may be used to monitor water temperature of the draining water.

Inlet 26 can receive water from a filtered water source as represented by arrow 30 and/or an unfiltered water source as represented by arrow 32. In some cases, by making use of the vibratory scale reducing feature described below, the need for a filtered water source may be eliminated. An inlet flow control device 34 (e.g., a valve) may be located between the inlet 26 and both water sources to allow for selection between filtered and unfiltered water and to generally control the flow of water to the inlet 26 (e.g., under control of a controller 50 which receives water level signals from one or more sensors 65). Where only one source of water is provided, the flow control device 34 controls the flow from just the one source. A pre-selected water or fill level may be set. The fill level may be monitored using the water level sensor 65 (or multiple water level sensors) that provides an indication to the controller 50 of the level of the water within the heating chamber 18, including at least that sufficient water is present to operate the resistive heating elements in order to generate steam. The sensor(s) 65 may be within the main heating chamber 18 as shown, or could be contained in a housing unit that is placed alongside the main heating chamber and includes a path of fluid communication with the heating chamber (as might be provided by tubing).

Controller 50 is used to control flow of water to the heating chamber 18 through the inlet 26 and from the heating chamber through the outlet 28 and may also be used to activate and deactivate the heating elements 20 (e.g., in response to an indication received from a user interface 54 including a generator OFF/ON input). As steam is produced it exits the generator along path 70 (e.g., steam flow may be controlled by valve 52) and the water level in the heating chamber 18 drops. When the water level sensor(s) 65 detect a drop below a desired level, more water is added. This process repeatedly occurs during steam generation, and as water is boiled within the heating chamber minerals in the water remain and build-up over time, creating the potential for such minerals to deposit as scale on the surfaces within the heating chamber.

In this regard, the steam generator includes one or more sidewall mounted vibratory mechanisms 80 that operate to cause the water within the heating chamber 18 to vibrate. In the illustrated embodiment a series (here 3) of vibratory mechanisms 80 are distributed along the sidewall of the tank so as to be aligned vertically and/or horizontally with the resistive heating element(s) 20. However, other configurations are possible. Each vibratory mechanism 80 may be in the form of a transducer such as a high frequency transducer. By way of example, an ultrasonic transducer (e.g., of piezoelectric type) may be used, where each transducer is driven by a common frequency generator or where each transducer is driven by an independent frequency generator. The ultrasonic waves produced by the ultrasonic transducer are transmitted through the steam generator wall and cause the water to vibrate rapidly. The rapid vibration of the water within the steam generator inhibits scale build-up on the internal surfaces of the steam generator, including the heating element(s) 20. In some cases a bubbling effect within the water may be produced.

Thus, the need for use of pre-treated water can be significantly reduced or eliminated, and the need to run deliming operations on the steam generator can be significantly reduced or eliminated. The ultrasonic vibrations may also aid in removing any scale that has built up in the steam generator for any reason. Thus, production of ultrasonic vibrations during deliming operations may aid in the speed and/or effectiveness of the delime operation. Reduction of scale build-up on the heating element(s) 20 also enhances overall, long-term energy efficiency of the steam generator.

In one implementation, the ultrasonic transducer(s) 80 may be continually operated during all periods of steam generator operation, and only stopped when the steam generator is turned off. Alternatively, the transducer(s) 80 may be operated periodically or intermittently during steam generator operation. As noted above, the ultrasonic transducer(s) 80 may also be operated during deliming.

In another implementation, the ultrasonic transducer(s) 80 may be occasionally or periodically operated according to one or more predefined parameters. For example, the ultrasonic transducer(s) 80 may turned on for a defined time period based upon a triggering parameter such as (i) duration of steam generator operation, (ii) amount of water added to the steam generator over time, (iii) number of cooking cycles of an associated steam oven or (iv) some other parameter indicative of potential scale build-up in the steam generator.

In some implementations the triggering parameters can be adjusted through the control system interface (e.g., by service personnel) to account for known factors such as the hardness of the water being used at a location of steam generator install.

In one implementation the ultrasonic frequency of the transducer(s) 80 may be maintained constant (e.g., a frequency in the range of 25 kHz to 75 kHz, though other variations are possible). In other implementations the ultrasonic frequency may be varied during the course of transducer operation to better inhibit the scale formation. The transducer(s) 80 could be operated at one frequency or frequency range for scale inhibition and at another frequency or frequency range for scale removal.

In some applications acoustic insulation could be included around the ultrasonic transducer(s) 80 and/or steam generator tank 12 to reduce any noise produced to an acceptable level according to the environment in which the steam generator is being used.

While the above description focuses on the use of one or more ultrasonic transducer(s) on a sidewall of the steam generator, it is recognized that one or more transducer(s) could be positioned on a bottom wall. Furthermore, although an external transducer is shown, it is recognized that the transducer could be located internal of the steam generator as well. The size and power output of the transducer(s) may vary depending upon the size/volume of the steam generator.

As suggested in FIG. 1, the steam cooker 10 may further include a superheater arrangement 90 along the steam path 70. The superheater includes one or more resistive heating elements 92 (e.g., external or internal of the steam path) for transferring additional heat to the steam traveling along the steam path 70 for the purpose of superheating the steam. Generally, steam is considered superheated when the temperature of the steam is increased above 212 degrees F. without pressurization. In such arrangements scale deposits can also occur within the supherheater 90. To reduce such scale build-up one or more ultrasonic transducer(s) 82 may be located on the steam generator sidewall 25 proximate the steam outlet to the steam path 70 so that some vibration will be transferred along the steam path structure to the surfaces of the superheater 90, which in some cases can deter scale particles (borne by the steam flow) from attaching to the surfaces of the superheater. One or more ultrasonic transducer(s) 84 could also be attached directly to the superheater 90 as shown for more effective vibratory action. In some circumstances, one, two or all three of the transducers 80, 82 and 84 may be implemented in a single steam cooker.

Although resistive heating elements are primarily described above for the steam generator and the superheater, it is also recognized that other heating devices (e.g., gaseous heat exchangers carrying combustion gases) could be used. Moreover, such ultrasonic scale control could also be implemented in steam generators used for purposes other than steam cookers (e.g., such as for steam production in warewash machines) and the ultrasonic scale control could also be implemented in other types of water heating tanks (e.g., such as hot water booster tanks used to heat rinse water in warewash machines).

By way of example, a warewash machine 100 is shown schematically in FIG. 3 and includes one or more wash and/or rinse chamber(s) 102 accessible by one or more door(s) 104. The wash and/or rinse chamber(s) may include one or more spray arm(s) 106 (stationary or rotating, with associated spray nozzles) for spraying wash and/or rinse liquid. The wash liquid may be recirculated via a sump 108, recirculation line 110 and pump 112. The rinse liquid may be fresh water delivered by inlet line 114 to a booster tank 116 that heats the water to be delivered by line 118 to the spray arms. The warewash machine may also include a steam generator 120 that delivers steam by a line 122 to one or more steam nozzles 124 in the wash chamber. Further details regarding warewash machines (both box-type and conveyor-type) can be found in U.S. Pat. Nos. 8,663,395 and 8,679,261, which are incorporated herein by reference. Referring again to FIG. 3, each of the hot water booster 116 and/or the steam generator can include one or more respective ultrasonic transducer(s) 126, 128 for the purpose of scale reduction as described above.

It is to be clearly understood that the above description is intended by way of illustration and example only, is not intended to be taken by way of limitation, and that other changes and modifications are possible.

What is claimed is:

1. A steam cooker, comprising:
a steam cooking chamber;
a steam generator external of the steam cooking chamber and plumbed to deliver steam from a steam outlet of the steam generator to a steam inlet of the steam cooking chamber, the steam generator including:
a tank structure providing a heating chamber for holding water;
at least one heating element associated with the tank structure for heating water within the heating chamber so as to generate steam; and
at least one transducer associated with the tank structure to cause water within the heating chamber to vibrate so as to reduce scale build-up on one or more surfaces within the heating chamber.

2. The steam cooker of claim 1 wherein the transducer comprises an ultrasonic transducer.

3. The steam cooker of claim 2 wherein the ultrasonic transducer is mounted externally of the heating chamber on a wall of the tank structure and below an operating water level of the heating chamber.

4. The steam cooker of claim 2 wherein the ultrasonic transducer is positioned within the heating chamber and below an operating water level of the heating chamber.

5. The steam cooker of claim 1 wherein the transducer is operated continuously during steam generating operation of the steam generator.

6. The steam cooker of claim 1 wherein the transducer is operated periodically or intermittently during steam generating operation of the steam generator.

7. The steam cooker of claim 1 wherein operation of the transducer is controlled according to a monitored triggering parameter.

8. The steam cooker of claim 1 wherein the heating element comprises one or more submerged resistive heating elements, and a plurality of transducers are located on a sidewall of the tank and aligned vertically and horizontally with the resistive heating elements.

9. A steam generator for generating steam by boiling water, the steam generator including:
a tank structure providing a heating chamber for holding water and including a water inlet, a steam outlet and a water drain outlet;
at least one heating element for heating water within the heating chamber so as to generate steam; and
at least one transducer located on or within the tank structure to cause water within the heating chamber to vibrate so as to reduce scale build-up on one or more surfaces within the heating chamber.

10. The steam generator of claim 9 wherein the transducer comprises an ultrasonic transducer.

11. The steam generator of claim 9 wherein the ultrasonic transducer is mounted externally of the heating chamber on a wall of the tank structure and below an operating water level of the heating chamber.

12. The steam generator of claim 10 wherein the transducer is operated continuously during steam generating operation of the steam generator.

13. The steam generator of claim 9 wherein operation of the transducer is controlled according to a monitored triggering parameter.

14. The steam generator of claim 9 wherein the heating element comprises one or more submerged resistive heating elements, and a plurality of transducers are located on a sidewall of the tank and aligned vertically and horizontally with the resistive heating elements.

15. A water heating apparatus, including:
a tank structure providing a heating chamber for holding water and including a water inlet and a water outlet;
at least one heating element for heating water within the heating chamber;
and a transducer located on or within the tank structure to cause water within the heating chamber to vibrate so as to reduce scale build-up on one or more surfaces within the heating chamber.

16. The apparatus of claim 15 wherein the transducer comprises an ultrasonic transducer.

17. The apparatus of claim 16 wherein the ultrasonic transducer is mounted externally of the heating chamber on a wall of the tank structure and below an operating water level of the heating chamber.

18. The apparatus of claim 15 wherein the transducer is operated either continuously during water heating or intermittently during water heating.

19. The apparatus of claim 15 wherein operation of the transducer is controlled according to a monitored triggering parameter.

20. A warewasher including the water heating apparatus of claim 15, further comprising:
a set of spray nozzles plumbed to receive heated water for rinsing from the water heating apparatus, and to spray the heated water within a ware cleaning chamber or spray zone of the warewasher.
